(19) United States
(12) Patent Application Publication
(10) Pub. No.: US 2026/0101865 A1
(43) Pub. Date: Apr. 16, 2026

(54) VEHICLE MOUNTED MULTIFUNCTIONAL PET NEST

(71) Applicant: YIWU ZHONGYUN CAR SUPPLIES CO.,LTD, Jinhua (CN)

(72) Inventor: LINGMIN QIAN, Suzhou (CN)

(21) Appl. No.: 18/959,796

(22) Filed: Nov. 26, 2024

(30) Foreign Application Priority Data
Oct. 11, 2024 (CN) 202411415509.2

(51) Int. Cl. A01K 1/02; A01K 1/035

(52) U.S. Cl. CPC A01K 1/0272; A01K 1/0353

(57) ABSTRACT

A vehicle mounted multifunctional pet nest is provided, which includes a first nest body and a second nest body; the first nest body includes a first surface, a second surface, and a third surface; a bottom of the first nest body is the third surface, the first surface is provided on two symmetrical edges of the third surface, the second surface is provided on an adjacent edge of the first surface; adjacent first and second surfaces are connected by a first zipper; a bottom of the second nest body is the third surface, a first bag is provided on an outer side of the first surface, a second bag is provided on an outer side of the second surface. Adjacent edges of the first and second bags are connected by a second zipper to solve a problem that existing pet nests cannot be used for both vehicle and home.

### CROSS-REFERENCE TO RELATED APPLICATIONS

This application claims priority to Chinese Patent Application No. 202411415509.2, filed on October 11, 2024, which is hereby incorporated by reference in its entirety.

### TECHNICAL FIELD

The present disclosure relates to the field of pet nest technologies, and in particular, to a vehicle mounted multifunctional pet nest.

### BACKGROUND

With the improvement of people’s living standards nowadays, there are more and more pet enthusiasts, and the types of pets are also different. Pet cats and dogs are relatively gentle and are also the choice of most people. Therefore, when camping or driving outdoors, it is common to bring pets and pet nests together. However, the existing pet nests cannot be used for both vehicle and home purposes, which increases the cost of raising and storage space.

### SUMMARY

The present disclosure provides a vehicle mounted multifunctional pet nest to solve the problem that existing pet nests cannot be used for both vehicles and homes, thereby increasing the cost of raising and storage space.

In order to achieve the above objectives, the present disclosure provides the following solution: a vehicle mounted multifunctional pet nest, including a first nest body and a second nest body; the first nest body includes a first surface, a second surface, and a third surface; a bottom of the first nest body is the third surface, the first surface is provided on two symmetrical edges of the third surface; the second surface is provided on an adjacent edge of the first surface; adjacent first surface and second surface are connected by a first zipper; a bottom of the second nest body is the third surface; a first bag is provided on an outer side of the first surface and a second bag is provided on an outer side of the second surface; adjacent edges of the first bag and the second bag are connected by a second zipper.

In some embodiments of the present disclosure, the first surface is larger in size than the second surface, and detachable straps are provided at a top of each of the first and second surfaces.

In some embodiments of the present disclosure, a wool-surface Velcro is provided on inner sides of bottoms of the first and second surfaces respectively, and a hook-surface Velcro is provided on inner sides of the first and second bags respectively.

In some embodiments of the present disclosure, the third surface is pocket shaped, a traction rope is provided on a top of the third surface, a cushion plate is provided in a middle of the third surface, and a plurality of anti-slip protrusions are provided on an outer side of a lower of the third surface.

In some embodiments of the present disclosure, one side of the third surface is provided with a third zipper configured to control opening and closing.

The present disclosure provides the beneficial effects of the vehicle mounted multifunctional pet nest: the first surface of the vehicle mounted pet nest is folded and placed in the first bag, and the second surface is folded and placed in the second bag. The first bag and the second bag are connected by a second zipper to form a home style pet nest, thereby achieving both vehicle and home use.

### BRIEF DESCRIPTION OF DRAWINGS

The accompanying drawings, which form a part of the present application, are used to provide further understanding of the present disclosure. It is obvious that the drawings described below are only some embodiments of the present disclosure. For those skilled in the art, other drawings can be obtained based on these drawings without creative work.

FIG. 1 is an overall schematic diagram of a pet nest of the present disclosure.

FIG. 2 is a schematic diagram of a first bag and a second bag that are unfolded of the present disclosure.

FIG. 3 is a schematic diagram of an overall disassembly of the present disclosure.

FIG. 4 is an overall state diagram of a second nest body of the present disclosure.

FIG. 5 is a decomposition schematic diagram of a third surface of the present disclosure.

### DESCRIPTION OF EMBODIMENTS

Below, the technical solutions in the embodiments of the present disclosure will be clearly and completely described in combination with the accompanying drawings. Obviously, the described embodiments are only a part of the embodiments of the present disclosure, not all of them. Based on the embodiments of the present disclosure, all other embodiments obtained by those skilled in the art without creative work are within the protection scope of the present disclosure.

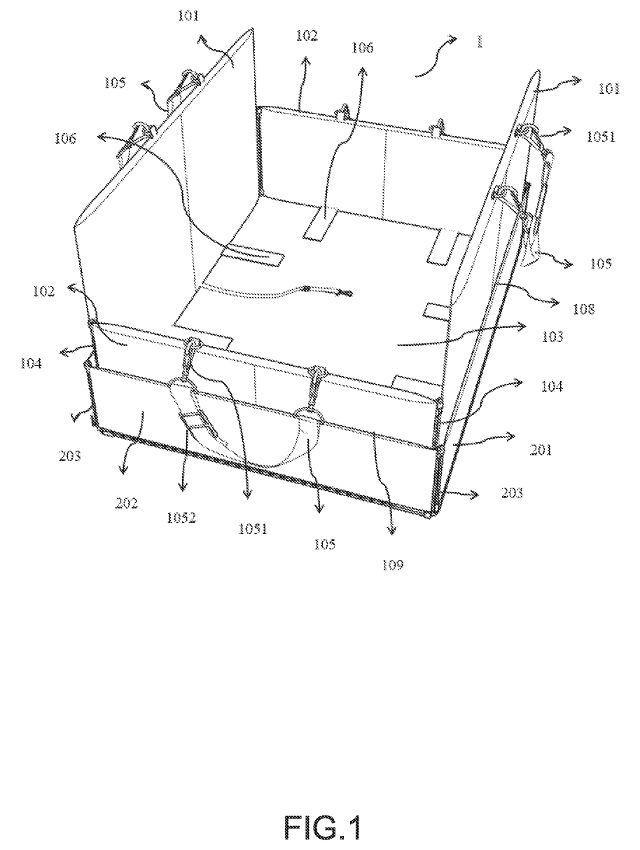

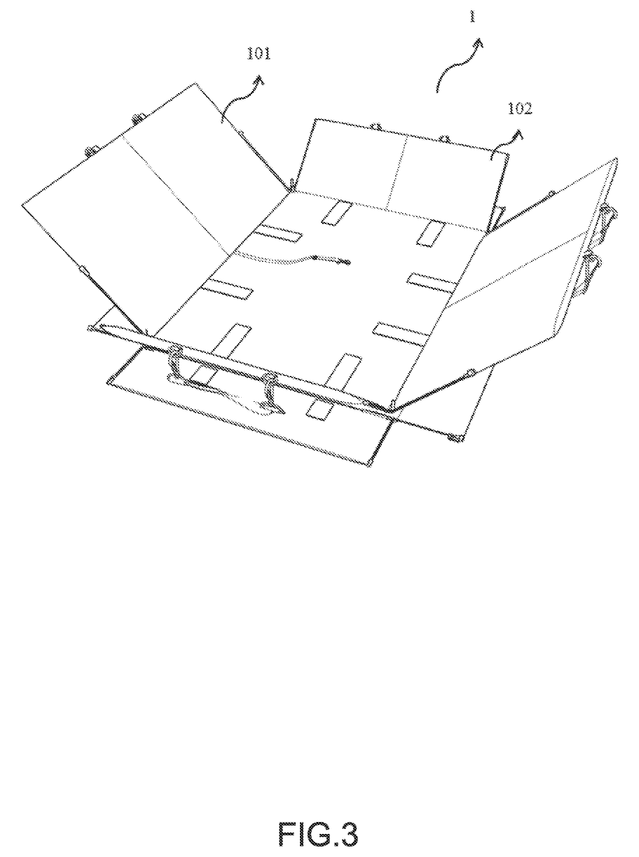

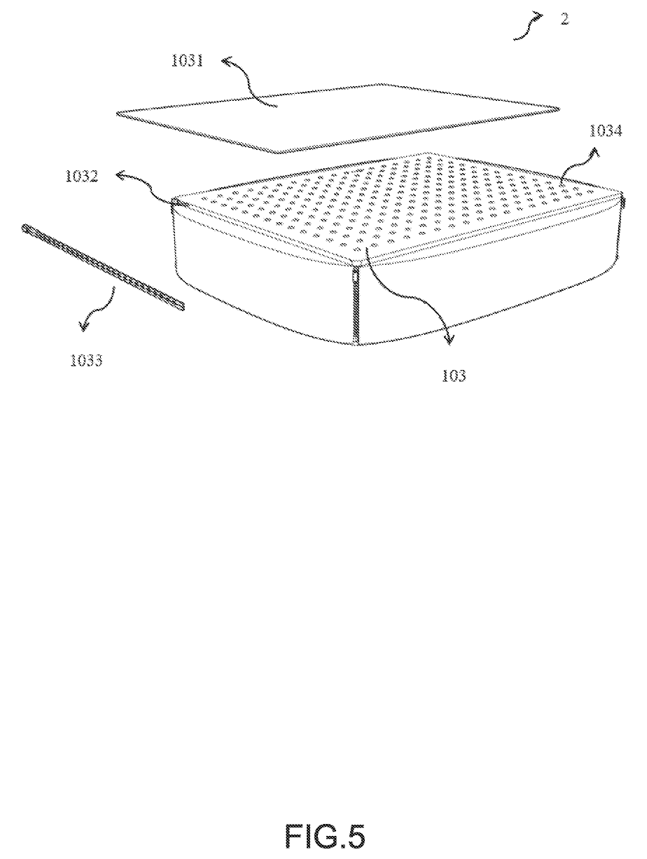

As shown in FIGS. 1-5, a vehicle mounted multifunctional pet nest is provided in an embodiment of the present disclosure, which includes a first nest body 1 and a second nest body 2. The first nest body 1 includes a first surface 101, a second surface 102, and a third surface 103. A bottom of the first nest body 1 is the third surface 103, the first surface 101 is provided on two symmetrical edges of the third surface 103. The second surface 102 is provided on an adjacent edge of the first surface 101; adjacent first surface 101 and second surface 102 are connected by a first zipper 104.

A bottom of the second nest body 2 is the third surface 103; a first bag 201 is provided on an outer side of the first surface 101, and a second bag 202 is provided on an outer side of the second surface 102. Adjacent edges of the first bag 201 and the second bag 202 are connected by a second zipper 203.

In an implementation mode, the first nest body 1 is rectangular in shape and made of fabric or leather material. In this embodiment, the first nest body 1 has an upper opening and the third surface 103 at its bottom. The first surface 101 is provided on two opposite edges of the first nest body 1, and the second surface 102 is provided on adjacent edges of two of the first surfaces 101. Both the first surface 101 and the second surface 102 are connected to the third surface 103 by stitching. In order to facilitate the disassembly and assembly of the first surface 101 and the second surface 102 during use, the first zipper 104 is provided on adjacent edges of the first surface 101 and the second surface 102, rendering disassembly and assembly simple and convenient.

In an implementation mode, straps 105 are provided at tops of the two first surfaces 101, which can be tied to a seat back or other fixed locations when driving out to fix the first nest body 1 and prevent it from shifting and causing traffic accidents. At the same time, the straps 105 are further provided at a top of the second surface 102, which allows for the placement of the first nest body 1 without being limited to a fixation direction. In specific environments, four straps 105 can also participate in fixing the first nest body 1 simultaneously.

Where, the four straps 105 are provided with locking buckles 1051 at two ends, which can be disassembled at one or two ends for auxiliary use when needed. In an implementation mode, adjustment buckles 1052 are provided on each strap 105 to adjust a length of the strap 105 as needed.

In this embodiment, the first surface 101 is located on two long edges of the third surface 103, and the second surface 102 is located on a short edge of the third surface 103. Therefore, a width of the first surface 101 is greater than that of the second surface 102, and at the same time, a height of the first surface 101 is also greater than that of the second surface 102. Its function is that when the strap 105 on the first surface 101 is closed and lifted, a raised part of the first surface 101 will also be close to a center, thereby achieving a sealing effect on the first nest body 1 and preventing the pet inside from jumping out.

In this embodiment, a traction rope 107 smaller than a size of the first nest body 1 is provided on the third surface 103 of the first nest body 1. One end of the traction rope 107 is fixed at a connection between the first surface 101 or the second surface 102 with an inner side of the third surface 103 by stitching, which limits the pet inside from leaving the first nest body 1 and running around, which causes chaos inside the vehicle. The other end of the traction rope 107 is provided with a movable connection buckle 1071, which facilitates a connection with a collar or harness on the pet’s body.

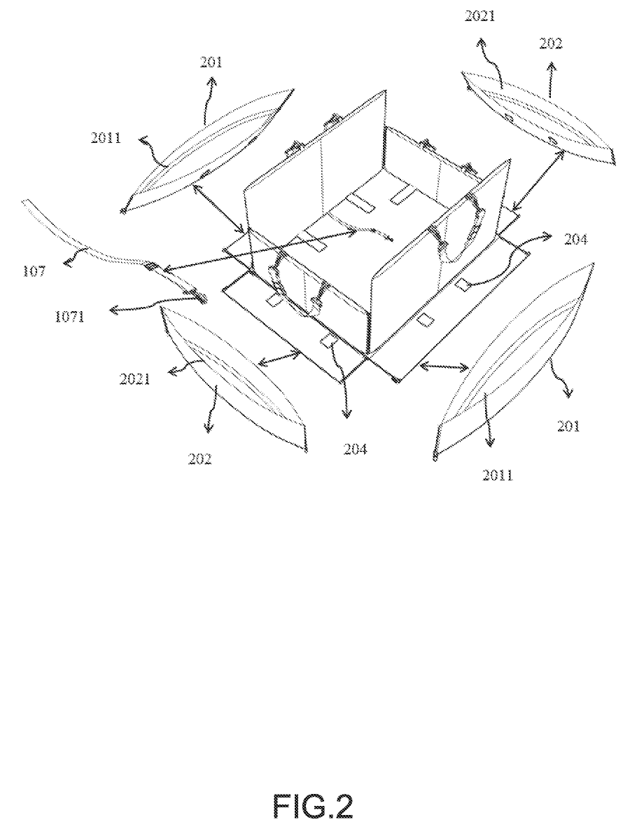

As shown in FIGS. 1-2, in this embodiment, a bottom of the second nest body 2 is the third surface 103 shared with the first nest body 1. The first bag 201 is provided on an outer side of the first surface 101, and the second bag 202 is provided on an outer side of the second surface 102. Bag openings of the two bags are located below, and outer edges of the bag openings are connected to the third surface 103 by stitching. At the same time, adjacent edges of the two bags are connected by a second zipper 203. In this way, a first storage pocket 108 and a second storage pocket 109 can be formed between the first bag 201 with the first surface 101, and between the second bag 202 with the second surface 102, rendering it convenient to store some pet supplies and small items.

Where, heights of the first bag 201 and the second bag 202 should be a half of a height of the second surface 102.

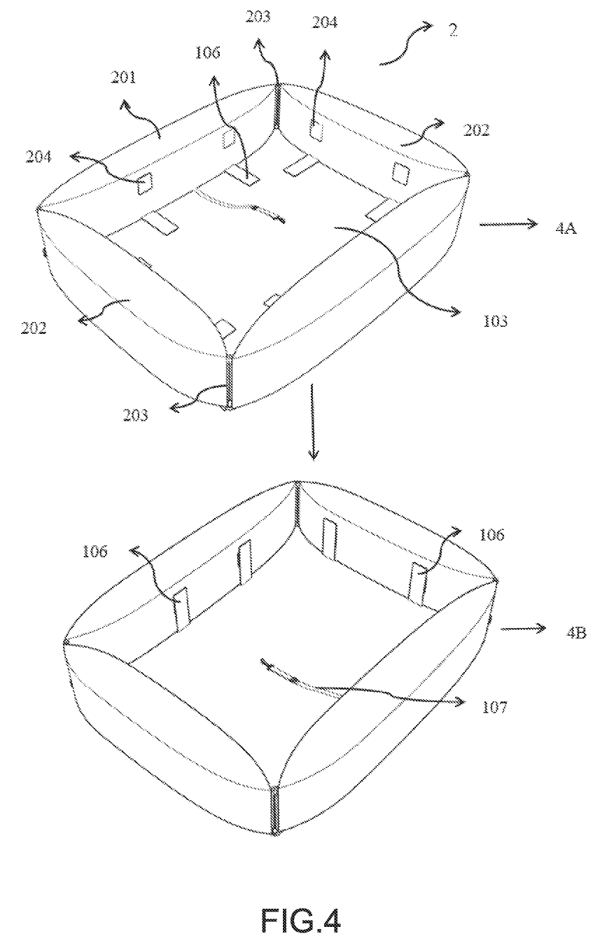

After arriving at a destination or returning home from a trip, in order to facilitate the entry and exit of the pet into the pet nest and the storage of the straps on the first surface 101 and the second surface 102, as shown in FIGS. 2-4, the second zipper 203 is opened and unfolded to unfold the first bag 201 and the second bag 202. Then, the first zipper 104 is pulled down to unfold the first surface 101 and the second surface 102. At this time, the first surface 101 is bent into a roll and loaded into the first bag 201 from the first bag opening 2011 under the first bag 201; similarly, the second surface 102 is bent into a roll and loaded into the second bag 202 from a second bag opening 2021 under the second bag 202. Finally, the first bag 201 and the second bag 202 are erected, and the second zipper 203 is pulled up, thus it is converted into the second nest body 2, as shown in FIG. 4A, its height is lower than that of the first nest body 1, rendering it convenient for the pet to enter and exit and easy to operate.

Where, the straps 105 can also be loaded into a corresponding bag along with the first surface 101 and the second surface 102.

In an implementation mode, a hook-surface Velcro 204 is provided on inner sides of the first bag 201 and the second bag 202, and correspondingly, a wool-surface Velcro 106 is provided on the third surface 103. The two are adhered to achieve sealing of the two bags, which can prevent the pet from stepping on and squeezing out the first surface 101 and the second surface 102 inside the bags, which causes a deformation of the second nest body 2, as shown in FIG. 4B.

Where, one end of the wool-surface Velcro 106 is fixed at a connection between the first bag 201 with the third surface 103 and at a connection between the second bag 202 with the third surface 103 by stitching, its position is corresponded to the hook-surface Velcro 204.

In this embodiment, the third surface 103 is pocket shaped, an opening 1032 is provided on a side of the third surface 103, and a hard cushion plate 1031 is provide in the third surface 103 to ensure an overall structural stability of the first nest body 1 and the second nest body 2. A third zipper 1033 is provided on the opening 1032 on its side to control opening and closing, rendering it convenient to access the cushion plate 1031.

In an implementation mode, a plurality of anti-slip protrusions 1034 made of plastic material are provided at a bottom of the third surface 103 through hot stamping technology, which can prevent the pet nest from easily sliding and reduce a friction between the third surface 103 and the ground.

The present application has been described in detail with reference to the aforementioned embodiments, those skilled in the art should understand that they can still modify the technical solutions described in the aforementioned embodiments, or equivalently replace some of the technical features; and these modifications or substitutions do not deviate from the essence of the corresponding technical solutions from the scope of the technical solutions of the various embodiments of the present application.

What is claimed is:

1. A vehicle mounted multifunctional pet nest, comprising a first nest body and a second nest body;
the first nest body comprises a first surface, a second surface, and a third surface; a bottom of the first nest body is the third surface, the first surface is provided on two symmetrical edges of the third surface; the second surface is provided on an adjacent edge of the first surface; adjacent first surface and second surface are connected by a first zipper;
a bottom of the second nest body is the third surface; a first bag is provided on an outer side of the first surface and a second bag is provided on an outer side of the second surface; adjacent edges of the first bag and the second bag are connected by a second zipper.

2. The vehicle mounted multifunctional pet nest according to claim 1, wherein the first surface is larger in size than the second surface, and detachable straps are provided at a top of each of the first and second surfaces.

3. The vehicle mounted multifunctional pet nest according to claim 2, wherein a wool-surface Velcro is provided on inner sides of bottoms of the first and second surfaces respectively, and a hook-surface Velcro is provided on inner sides of the first and second bags respectively.

4. The vehicle mounted multifunctional pet nest according to claim 1, wherein the third surface is pocket shaped, a traction rope is provided on a top of the third surface, a cushion plate is provided in a middle of the third surface, and a plurality of anti-slip protrusions are provided on an outer side of a lower of the third surface.

5. The vehicle mounted multifunctional pet nest according to claim 4, wherein one side of the third surface is provided with a third zipper configured to control opening and closing.
